(19) United States
(12) Patent Application Publication
(10) Pub. No.: US 2008/0187145 A1
(43) Pub. Date: Aug. 7, 2008

(54) System For and Method of Increasing Convenience to Users to Drive the Purchase Process For Hearing Health That Results in Purchase of a Hearing Aid

(75) Inventors: Mark Burrows, Princeton, NJ (US); John Cronin, Jericho, VT (US); Nancy Edwards, Jericho, VT (US); Steven D. Gabel, Sloatsburg, NY (US); Tushar Narsana, Winooski, VT (US); Steven A. Shaya, Highlands, NJ (US); John Anthony Singarayar, Skillman, NJ (US)

Correspondence Address: MCCARTER & ENGLISH, LLP, FOUR GATEWAY CENTER, 100 MULBERRY STREET, NEWARK, NJ, 07102, US

(73) Assignee: Johnson & Johnson Consumer Companies, Inc.

(21) Appl. No.: 11/570,459

(22) PCT Filed: Jun. 14, 2005
(86) PCT No.: PCT/US05/20880

§ 371 Date: Oct. 31, 2007

Related U.S. Application Data
(60) Provisional application No. 60/579,369, filed on Jun. 14, 2004.
(60) Provisional application No. 60/579,368, filed on Jun. 14, 2004.
(60) Provisional application No. 60/579,420, filed on Jun. 14, 2004.
(60) Provisional application No. 60/579,438, filed on Jun. 14, 2004.
(60) Provisional application No. 60/579,366, filed on Jun. 14, 2004.
(60) Provisional application No. 60/579,479, filed on Jun. 14, 2004.
(60) Provisional application No. 60/579,220, filed on Jun. 14, 2004.
(60) Provisional application No. 60/579,367, filed on Jun. 14, 2004.
(60) Provisional application No. 60/579,946, filed on Jun. 15, 2004.
(60) Provisional application No. 60/579,947, filed on Jun. 15, 2004.
(60) Provisional application No. 60/579,948, filed on Jun. 15, 2004.
(60) Provisional application No. 60/582,681, filed on Jun. 24, 2004.

(51) Int. Cl. H04R 29/00

(52) U.S. Cl. 381/60

(57) ABSTRACT

Method and system (400) for becoming aware of some hearing loss and the need for a professional hearing test. Simple and professional hearing testing provide an understanding of the improvement in the quality of life that can be achieved through use of a hearing aid. Ordering and fitting of the hearing aid, and training on use of a hearing aid, are performed to further demonstrate and provide for improved quality of life. The system (400) includes a user (410), a hearing test unit (415), a test administrator computer (420), a pair of headphones (422), a keyboard (423), a monitor (426), a series of hearing test programs (446), a central hearing health system (440), a database, a device (433), and a set of individual results.

### CROSS REFERENCE TO RELATED APPLICATION

This application claims the benefit of U.S. Provisional Application No. 60/582,681, filed Jun. 24, 2004; U.S. Provisional Application No. 60/579,369, filed Jun. 14, 2004; U.S. Provisional Application No. 60/579,947, filed Jun. 15, 2004; U.S. Provisional Application No. 60/579,948, filed Jun. 15, 2004; U.S. Provisional Application No. 60/579,368, filed Jun. 14, 2004; U.S. Provisional Application No. 60/579,420, filed Jun. 14, 2004; U.S. Provisional Application No. 60/579,438, filed Jun. 14, 2004; U.S. Provisional Application No. 60/579,366, filed Jun. 14, 2004; U.S. Provisional Application No. 60/579,479, filed Jun. 14, 2004; U.S. Provisional Application No. 60/579,220, filed Jun. 14, 2004; U.S. Provisional Application No. 60/579,946, filed Jun. 15, 2004; U.S. Provisional Application No. 60/579,367, filed Jun. 14, 2004; each of which is assigned to the assignee of this application and incorporated by reference herein.

### FIELD OF THE INVENTION

The present invention relates to a system for and a method of driving the purchase chain for healthy hearing in which a hearing aid is a result of the purchase. The present invention relates to a system with a central hearing health database that provides user information that is built upon over the purchase chain and is accessible to other stages of the purchase chain.

### BACKGROUND OF THE INVENTION

More than 25 million Americans experience hearing loss, including one out of four people older than 65. Hearing loss can result from infections, strokes, head injuries, some medicines, tumors, other medical problems, or even too much earwax. It can also result from repeated exposure to very loud noise, such as music, power tools, or jet engines. Changes in the way the ear works as a person ages can also affect hearing.

For most people who have a hearing loss, there are ways to fix the problem. If an individual has trouble hearing, that individual can visit a doctor or hearing health care professional to find out if he or she has a hearing loss and, if so, to determine a remedy. The U.S. Food and Drug Administration (FDA) and similar governing bodies in other countries have rules to make sure that treatments for hearing loss—medicines, hearing aids, and other medical devices—medicines, hearing aids, and other medical devices—are tried and tested.

However, most people do not even know that they have a hearing loss. Typical indications that an individual has hearing loss include: (1) shouting when talking to others, (2) needing the TV or radio turned up louder than other people do, (3) often having to ask people to repeat what they say because the individual can't quite hear them, especially in groups or when there is background noise, (4) not being able to hear a noise when not facing the direction it's coming from, (5) seeming to hear better out of one ear than the other, (6) having to strain to hear, (7) hearing a persistent hissing or ringing background noise, and (8) not being able to hear a dripping faucet or the high notes of a violin. If an individual experiences one of more of the above indications, the individual should see his or her doctor or hearing health care professional for further testing for potential hearing loss.

To determine what kind of hearing loss the individual has and whether all the parts of the individual's ear are functioning, the person's doctor may want him or her to take a hearing test. A health-care professional that specializes in hearing, such as an audiologist, often gives these tests. Audiologists are usually not medical doctors, but they are trained to perform hearing tests and interpret the results. Hearing tests are painless.

If an individual knows he or she has some hearing loss, the usual reaction is to put off visiting an audiologist because he or she has no idea what having a hearing aid would do to improve his or her quality of life. Potential hearing aid users do not have a way to experience what their individual improvement would be if a corrective hearing aid were used. Thus, the motivation to get the problem fixed is much less than if the individual could experience the benefits of correction at the time of the test.

If a professionally administered hearing test shows that is the individual has a hearing loss, there may be one or more ways to treat it. Possible treatments include medication, surgery, or a hearing aid. Hearing aids can usually help hearing loss that involves damage to the inner ear. This type of hearing loss is common in older people as part of the aging process. However, younger people can also have hearing loss from infections or repeated exposure to loud noises.

In a well-known method of testing hearing loss in individuals, the threshold of the individual's hearing is typically measured using a calibrated sound-stimulus-producing device and calibrated headphones. The measurement of the threshold of hearing takes place in an isolated sound room, usually a room in which there is very little audible ambient noise. The sound-stimulus-producing device and the calibrated headphones used in the testing are known in the art as an audiometer.

A professional audiologist performs a professional test by using the audiometer to generate pure tones at various frequencies between 125 Hz and 12,000 Hz that are representative of a variety of frequency bands. These tones are transmitted through the headphones of the audiometer to the individual being tested. The intensity or volume of the pure tones is varied until the individual can just barely detect the presence of each tone. For each pure tone, the intensity at which the individual can just barely detect the presence of the tone is known as the individual's air conduction threshold of hearing. Although the threshold of hearing is only one element among several that characterizes an individual's hearing loss, it is the predominant measure traditionally used to acoustically fit a hearing compensation device.

Known audiometers are of two main types: the manual and the “automatic” type. In the manual system for and method of testing hearing, a skilled operator adjusts the audiometer controls, thereby sending a plurality of audio signals through either earphones, loudspeakers, or bone vibrators to a subject sitting in a quiet room. The subject is requested to signal to the operator, by activating a switch connected to a pilot light, by raising a hand, or by any other visible or audible means, whenever he or she has heard the sound being sent. The operator watches for the subject's responses, interprets them, and translates them into written information on a chart. This information is represented by a graph called an audiogram, which represents the threshold of hearing of the subject for a plurality of audio frequencies.

In the automatic method known as the Bekesy method of hearing testing, the audiometer presents automatically changing tone frequencies to the subject while the intensity of the signal is controlled by the subject by means of a pushbutton switch activating a motor controlling the motion of an intensity attenuator. The subject's responses are also automatically recorded by a writing pen moving over a chart as the test progresses. While the Bekesy method was considered by those skilled in the art of audiology to be a major advance, it still requires the presence of a skilled operator and the use of rather sophisticated mechanical systems. Since the introduction of the Bekesy method, an automatic method of hearing testing has been proposed in U.S. Pat. No. 4,107,465, that dispenses with the need for a skilled operator and the use of rather sophisticated mechanical systems.

The standard diagnostic tests use tones at various amplitudes. However, beyond the individual's reaction to these tones, other factors may influence the individual's hearing needs. For example, speech intelligibility could be problematic for some individuals, that is, frequency loss in various ranges can severely impact the individual's ability to understand speech.

Once the audiologist is aware of the extent of the individual's hearing loss, the audiologist attempts to relay the hearing test results to the individual and help the individual decide whether to purchase a hearing aid that fits the his or her needs. Unfortunately, because the individual does not know how the hearing aid will improve his or her hearing, the individual relies solely on the audiologist's recommendations. At this step, many individuals delay the decision because of many factors, including price and lifestyle changes. Unfortunately, the individual has no idea what having a hearing aid would do to improve his or her quality of life.

The audiometer apparatus uses headphones when testing the individual's hearing. The results of the test are used to design a hearing aid, typically a hearing aid with a digital signal processor (DSP) that uses frequency and amplitude adjustments to create an amplifier and filter in the hearing aid that is customized to the user. However, it is difficult to calibrate the exact adjustment of the hearing-aid device to be worn by the individual based upon the use of headphones in the hearing test. A problem associated with the use of headphones to present tones to the individual is that, due to the unique acoustics of each individual's ear canal, the individual's perception of the sound transmitted by the headphones is different from the individual's perception of sound transmitted by the actual hearing-aid device in the individual's ear canal. Further, if the individual is to be further motivated to improve the quality of his or her life with any type of hearing aid device, the individual needs to have an aural experience that is close to the real experience of improved quality of life.

After the individual leaves the audiologist and awaits the arrival of the manufactured hearing aid so that it might be fitted, the individual has no way to technically describe to others what his or her hearing loss is, and how it has impacted his or her communication at home and at work. A new hearing aid initially presents learning challenges that impact the individual's acceptance of the hearing aid, making the individual likely to return it. An individual may believe that the hearing aid performs strangely. Unlike a prescription for eyeglasses that corrects to near perfect vision, hearing aids do not restore perfect hearing and may require a significant retraining period. This is particularly true regarding the way the individual interprets speech. Often, as a person loses his or her hearing within a certain frequency range, certain words become troublesome to hear and the individual continually asks a speaker to repeat the word. In essence, the individual is retraining his or her brain to associate the new sounds with existing concepts. Usually, the troublesome word is used in a sentence that provides more context for the brain to retrain itself. When a new hearing aid is used, the brain no longer recognizes the more correct audio signals because they were replaced by the retrained words that were based upon an incorrect audio signal presented to it by deficient hearing ability. The valuable time between leaving the audiologist's office after the test and returning for the hearing aid fitting could be a useful time to educate the individual to his or her specific learning needs.

Even after the individual has been trained and has accepted that the hearing aid improves his or her quality of life, other issues impact the use of hearing aids, for example, the cleaning and maintenance of the hearing aid. Current practice in cleaning hearing aids depends upon the users' memories. Hearing aid users are no different from consumers of other products: all want convenience. Cleaning a hearing aid is one more thing to remember, so it is not done faithfully. This issue has become even more important as hearing aids have become smaller. Primarily to overcome the stigma of wearing a hearing aid, manufacturers have miniaturized them to the point where completely-in-canal (CIC) hearing aids reside out of sight deep in the ear canal, proximate to the tympanic membrane (eardrum). This placement provides the overriding benefits of improving frequency response, reducing distortion due to jaw extrusion, and improving overall sound fidelity; however, it worsens the problem of earwax buildup.

The anatomy of the ear canal includes ceruminous glands that secrete a yellowish, wax-like substance called cerumen (earwax), which accumulates in the ear canal. Due to both the action of cilia located in the ear canal and the natural movements of the ear canal, the cerumen gradually migrates outward. When a hearing aid is inserted into the ear canal, it is susceptible to the effects of cerumen accumulation and migration. Cerumen often mixes with sloughed off skin and dirt, further impairing the performance of the hearing aid.

Acoustic speakers in most modern hearing aids are particularly susceptible to performance problems and damage from cerumen accumulation; initially, cerumen blocks the speaker port, occluding the acoustic path, in turn preventing sound waves from reaching the tympanic membrane. Eventually, the cerumen can penetrate the receiver housing, damaging the sensitive mechanical and electrical components whose failure necessitates repair or replacement of the hearing aid. Not only is the cost in time and money significant, but also individuals are uncertain whether their hearing is worsening or the hearing aid is malfunctioning. The net effect is diminished hearing-aid performance—and thus a diminished quality of life.

U.S. Pat. No. 6,349,790, incorporated by reference herein, describes a thermally activated cleaning element on the distal end of a hearing aid adjacent to the speaker, which retracts when heated by the inner ear to body temperature, then extends when cooled to room temperature. Upon removal of the hearing aid from the ear, the self-cleaning cerumen guard automatically removes any debris that has accumulated in the speaker port.

U.S. Pat. No. 5,401,920, incorporated by reference herein, discloses a replaceable and disposable wax guard that is affixed over the sound port of an in-the-ear hearing aid by means of a pressure sensitive tape. The filter itself is porous to sounds but is receptive to cerumen. While providing some level of protection against cerumen damage to the internal components of the hearing device, this and other similar types of filters become quickly soiled, resulting in poor device performance due to a blocked speaker port. As such, the patient must frequently replace the disposable filter. The small size of these devices often requires a high level of visual acuity and dexterity for such maintenance.

U.S. Pat. No. 5,327,500, incorporated by reference herein, discloses a cerumen barrier for a custom, in-the-ear hearing aid. The cerumen barrier consists of a small door covering the receiver port that can be manually rotated open to provide cleaning under the door and around the receiver port. While also providing some level of protection against cerumen to the internal components of the hearing aid, significant user intervention is relied upon to clean the filter.

With the exception of the '790 patent, each of these prior art devices has the profound shortcoming of relying on the memory of users; cerumen is simply collected and users must remember to manually clear it from the device. When users are unsure of or unhappy with their hearing aid's performance, they must bear the inconvenience and cost of taking them to their audiologists for assessment and adjustment. No in-home means is available by which individuals may test and calibrate their hearing aids to manufacturers' standards, ensuring optimal hearing aid performance; certainly, no such diagnostic test is generated automatically.

After a hearing aid is used and maintained for a while, the user grows accustomed to the improvement in his or her quality of life. However, the individual still finds it difficult to hear clearly in some instances, such as while watching television, listening to the stereo, going to a public place such as an opera or a restaurant, etc. The individual at many times desires more control over his or her hearing aid in specific situations, given that the hearing aid was designed for all generic situations.

### SUMMARY OF THE INVENTION

It is thus an object of this invention to provide a way for people to understand the natural loss of hearing to determine if the onset of hearing loss has occurred.

It is another object of this invention to provide a way for people to recognize their own hearing loss.

It is another object of this invention to simplify the process by which people purchase, use, and maintain hearing aids in treating their hearing loss.

It is another object of this invention to provide a way to help motivate a potential hearing aid user to visit an audiologist.

It is another object of this invention to provide a diagnosis and testing method that determines speech intelligibility as well as other factors, such as the impact of background noise, etc.

It is another object of this invention to provide a way to motivate an individual to purchase the correct hearing aid by assisting the individual in understanding the potential improvement to his or her quality of life.

It is another object of this invention to provide a way to motivate the individual to purchase the correct hearing aid by assisting the individual in understanding the potential improvement to his or her quality of life by providing an experience as close as possible to wearing the specific hearing aid that is to be ordered for him or her.

It is another object of this invention to provide a way to train the individual at home between leaving the audiologist's office after the test and returning for the hearing aid fitting.

It is another object of this invention to provide a way to train the individual with a newly acquired and fitted hearing aid.

It is another object of this invention to simplify the hearing aid diagnostic testing and maintenance process for use at home. It is a further object to provide a way of providing automatic, in-home remote diagnostic testing of the hearing aid, as frequently as daily, signaling users when the device is functioning improperly or requires service, etc.

It is another object of this invention to provide a way for individuals to improve their hearing in specific instances in which their hearing aids can be improved for those specific applications.

The present invention is system for and method of driving the hearing-health purchase process by focusing on individuals' hearing-health needs, beyond merely choosing and fitting the hearing aid. The present invention provides:
1) a way for people to recognize their own hearing loss using a low-cost compact disc (CD) test, such as described in “Low-Cost Hearing Testing System and Method of Collecting User Information”, International Application PCT/US2005/______, filed June ______, 2005, claiming priority of U.S. Provisional Application No. 60/579,369, filed Jun. 14, 2004 and assigned to the assignee of this application and incorporated by reference herein;
2) a way to know the steps to treat hearing loss by using an improved non-professional test performed over the Internet or via a telephone system, such as described in “A System for and Method of Conveniently and Automatically Testing the Hearing of a Person”, International Application PCT/US2005/______, filed June ______, 2005, claiming priority of U.S. Provisional Application No. 60/579,947, filed Jun. 15, 2004, assigned to the assignee of this application and incorporated by reference herein;
3) a way to help motivate a potential hearing aid user to visit the audiologist by providing an in-home, programmed, low-cost hearing amplifier having a limited time of use, such as described in “Low-Cost, Programmable, Time-Limited Hearing Health Aid Apparatus, Method of Use, and System for Programming Same”, International Application PCT/US2005/______, filed June ______, 2005, claiming priority of U.S. Provisional Application No. 60/579,948, filed Jun. 15, 2004, assigned to the assignee of this application and incorporated by reference herein;
4) a diagnosis and testing method that determines speech intelligibility as well as other factors, such as the impact of background noise, etc., via an in-home hearing aid tester, such as described in “Hearing Device Sound Simulation System and Method”, International Application PCT/US2005/______, filed June ______, 2005, claiming priority of U.S. Provisional Application No. 60/579,368, filed Jun. 14, 2004, assigned to the assignee of this application and incorporated by reference herein;
5) a way to motivate the individual to purchase the right hearing aid by assisting the individual in understanding the potential improvement to his or her quality of life by supplying a customized simulation (through headphones) of his or her assisted hearing after the initial audiologist's test, such as described in “System for Customized Training to Understand Human Speech Correctly With a Hearing Aid Device”, International Application PCT No. US2004/20387, filed Jun. 24, 2004, assigned to the assignee of this application and incorporated by reference herein;
6) a way to motivate the individual to purchase the right hearing aid by assisting the individual in understanding the potential improvement to his or her quality of life by supplying a customized simulation (through a demonstration hearing aid) of his or her assisted hearing, such as described in “Hearing Aid Demonstration Unit and Method of Using”, International Application PCT/US2005/______, filed June ______, 2005, claiming priority of U.S. Provisional Application No. 60/579,420, filed Jun. 14, 2004, assigned to the assignee of this application and incorporated by reference herein;
7) a way to train the individual at home after the initial audiologist's test and before the hearing aid fitting by supplying an in-home, customized training program on CD;
8) a way to optimize the individual's actual hearing aid during fitting by iteratively testing and reprogramming the hearing aid until the individual is satisfied with its performance, such as described in “System for and Method of Optimizing an Individual's Hearing Aid”, International Application PCT/US2005/______, filed June ______, 2005, claiming priority of U.S. Provisional Application No. 60/579,438, filed Jun. 14, 2004 assigned to the assignee of this application and incorporated by reference herein;
9) a way to train the user of a newly acquired fitted hearing aid by supplying an in-home, customized training program on CD, such as described in “At-Home Hearing Aid Training System and Method”, International Application PCT/US2005/______, filed June ______, 2005, claiming priority of U.S. Provisional Application No. 60/579,366, filed June 14, 2004, assigned to the assignee of this application and incorporated by reference herein;
10) a simplified hearing aid diagnostic testing and maintenance process and at-home hearing aid tester, such as described in “At-Home Hearing Aid Testing and Cleaning System and Method of Operating Same”, International Application PCT/US2005/______, filed June ______, 2005, claiming priority of U.S. Provisional Application No. 60/579,479, filed Jun. 14, 2004 and “At-Home Hearing Aid Tester and Method of Operating Same”, International Application PCT/US2005/______, filed June ______, 2005, claiming priority of U.S. Provisional Application No. 60/579,220, filed Jun. 14, 2004, both of which are assigned to the assignee of this application and incorporated by reference herein;
11) a way to improve the intelligibility of television audio output for a hearing-impaired individual by using that individual's hearing profile to clarify the voice portions of television audio and by allowing the individual to adjust the appearance of closed captioning to suit his or her preferences, such as described in “A System for and Method of Providing Improved Intelligibility of Television Audio for the Hearing Impaired”, International Application PCT/US2005/______, filed June ______, 2005, claiming priority of U.S. Provisional Application No. 60/579,946, filed Jun. 15, 2004, assigned to the assignee of this application and incorporated by reference herein; and
12) a business method and system that locally programs hearing aids and devices based upon users' specific needs, such as an opera or theater that programs a user's hearing aid by transmitting sound codes that are based on the pre-measured acoustics of the venue, such as described in “System For and Method of Offering an Optimized Sound Service to Individuals Within a Place of Business”, International Application PCT/US2005/______, filed June ______, 2005, claiming priority of U.S. Provisional Application No. 60/579,367, filed Jun. 14, 2004, assigned to the assignee of this application and incorporated by reference herein.

In a preferred embodiment of the present invention, a hearing loss testing and training data storage media provides for driving the hearing-health purchase process. The media includes at least one of (i) an executable hearing aid testing program including a plurality of testing units, (ii) an executable hearing aid training program including a plurality of training units, and (iii) hearing aid testing data. In addition, the media includes at least one of a plurality of hearing aid diagnosis units, such as digital signal processor (“DSP”) correction factors data, corresponding to a hearing loss profile obtainable based on performance of the hearing aid testing program. Also, the media includes at least one hearing aid product unit representative of a hearing aid product programmable to operate based on at least one of the hearing aid diagnosis units. Further, at least one of the training units is linked to at least one of (i) the hearing aid testing data and (ii) the at least one diagnosis units. When the media is executed by a suitable media player, the training program, based on user input data, such as provided over a communications network interface or at a local computer interface, accesses at least one of the training units on the media.

In a further preferred embodiment, the media includes incentive data, such as electronic coupons, linked to at least one of the testing units. In still a further preferred embodiment, the media includes at least one hearing aid maintenance program and at least one of the diagnosis units is indexed with user identification data.

In another preferred embodiment, the media includes hearing aid environment data, such as opera house acoustics data, including at least one sound code for programming, wirelessly or through wired means, a programmable hearing aid to operate using a modified version of at least one of the diagnosis units. The modified diagnosis unit includes DSP correction factors modified based on acoustic environment data for an identified location.

In a further preferred embodiment, the media includes multimedia hearing aid data, such as data for modifying text captioning or audio signals. Preferably, the multimedia data includes audio input modification data representative of DSP correction factors included in at least one of the diagnosis units.

In another embodiment of the present invention, an electronic audio signal modification device is provided for coupling to at least one electronic audio device including an audio signal output. The signal modification device includes a DSP for modifying input audio signals received from the electronic audio device using DSP correction factors received at a network communications interface and stored at the hearing loss testing and training data storage media of the present invention. The modified audio signals are used to drive an analog audio output device, such as speakers, which is coupled to the electronic audio device.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a prior art system diagram of a programmable hearing aid.

FIG. 2 is a diagram of the purchase chain of the invention.

FIGS. 3A and 3B are examples of a hearing test questionnaire.

FIG. 4 is a system diagram of interaction between a user and a central hearing computer system through various devices.

FIG. 5 is a flow chart of a method of implementing the purchase chain.

### DETAILED DESCRIPTION OF THE INVENTION

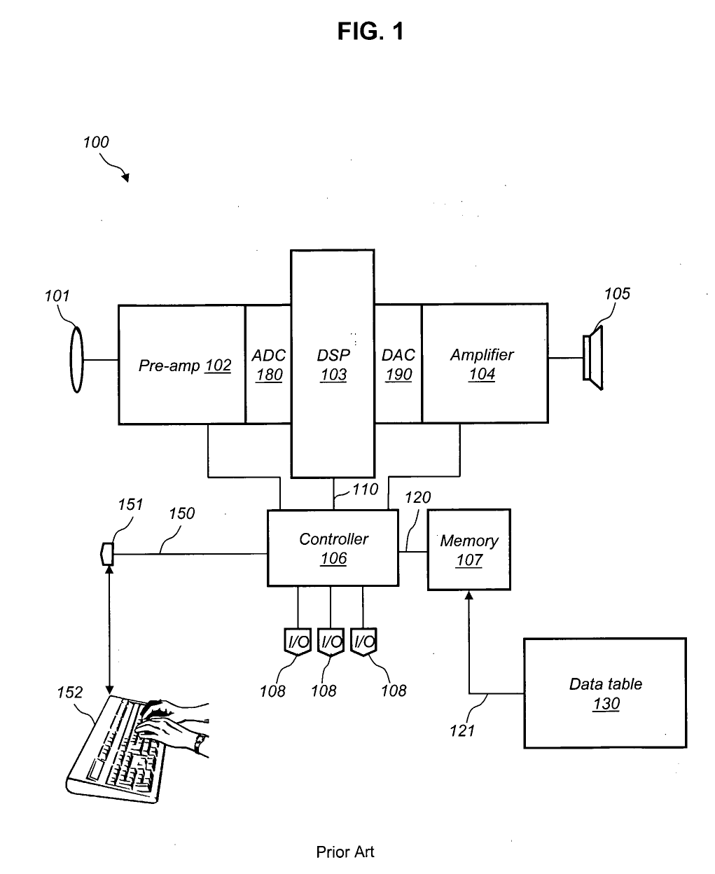

FIG. 1 is a block diagram illustrating the components of a basic prior art hearing aid 100, and basic prior art operation of a programmable hearing aid, which is programmable by a serial interface in order to be optimized for an individual user's hearing needs and preferences.

Basic hearing aid 100 consists of the following conventional components: a microphone 101, a pre-amplifier (pre-amp) 102, an analog-to-digital converter (ADC) 180, a digital signal processor (DSP) 103, a digital-to-analog converter (DAC) 190, an amplifier 104, an output speaker 105, a data table memory 130, an address and data bus 121, a memory 107, a controller 106, an address and data bus 120, an address and data bus 110, a plurality of input/output devices (I/O) 108, a programming connection 150, a socket connector 151, and a computer 152.

With basic hearing aid 100 in a user's ear, sound is collected as an analog signal in microphone 101. This signal is amplified using pre-amp 102, is converted from analog to digital in ADC 180, and then is processed by DSP 103 to meet the individual's unique requirements. The signal from DSP 103 is then converted from digital to analog using DAC 190. This analog signal is then amplified using amplifier 104 for transmission to output speaker 105. Microphone 101 and output speaker 105 have adjustable variable settings to control the input/output volume of sound to basic hearing aid 100.

A means of programming the hearing aid's DSP 103 in order to optimize the hearing aid for a user, is described, for example, in U.S. Pat. No. 6,201,875, incorporated by reference herein. Programming a DSP hearing aid requires that a user's specific hearing compensation requirements data, like amplitude versus frequency, be loaded from data table memory 130 via address and data bus 121 to memory 107 (such as an EEPROM). Controller 106 then accesses memory 107 via address and data bus 120 to load the hearing compensation requirements data onto DSP 103 via address and data bus 110. I/O 108, such as on/off, volume, and squelch, connected to controller 106 provide users with a degree of external control of basic hearing aid 100.

Programmable basic hearing aid 100 is connected to the programmer, such as described in U.S. Pat. No. 6,319,020, incorporated by reference herein, which describes a connection to a serial or parallel input for programming connection 150 in which socket connector 151 allows communication with an external circuit, such as computer 152 or comparable programming device. Building a serial interface for programming a hearing aid is described, for example, in U.S. Pat. No. 6,240,193, incorporated by reference herein.

In operation, controller 106 gets programmed data from data table memory 130 and loads it into memory 107. The programmed data is then used by DSP 103 when signals go through microphone 101 and pre-amp 102 to ADC 180. After DSP 103 operates on the input signal, DSP 103 outputs the modified and processed signal to DAC 190 and then to amplifier 104 to output speaker 105 of basic hearing aid 100. Controller 106 uses address and data bus 110, 120 and 121 to move the DSP data as needed. Controller 106 also provides connection to I/O 108 on/off, volume, or squelch external adjusters. In addition, controller 106 connects to programming connection 150, in which socket connector 151 allows communication with an external circuit, such as computer 152 allowing a user to program or direct controller 106.

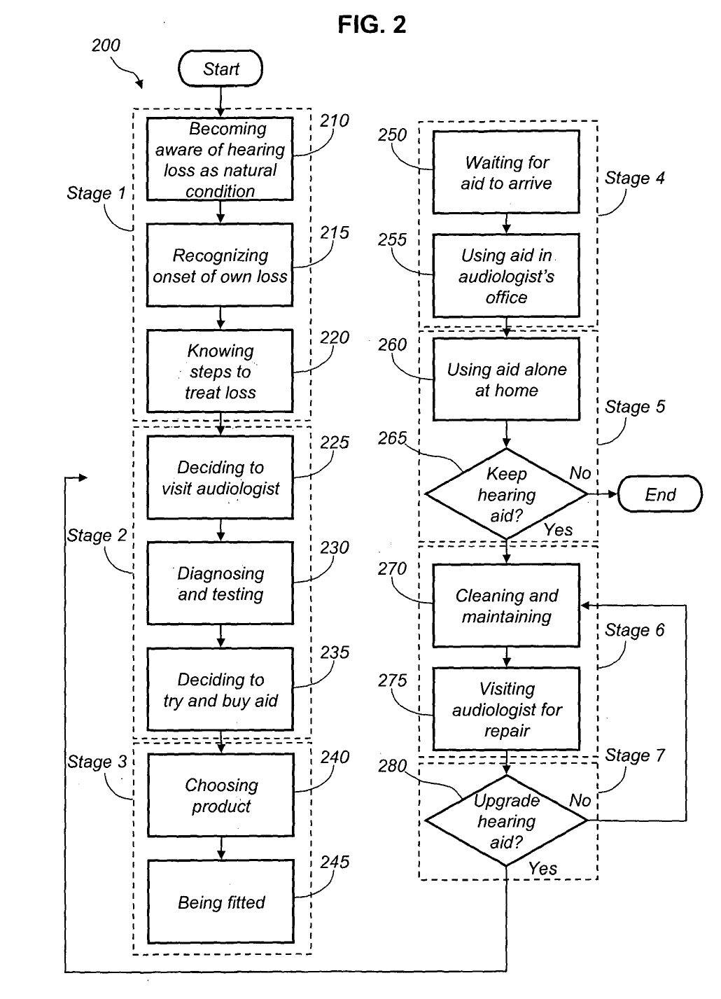

FIG. 2 is a flow diagram of a purchase chain method 200 of the invention. The purchase chain flow diagram is a representation of the interaction between the customer and a business entity. Businesses think through everything from educating the customer on their product or service to how to motivate the customer to try and buy the product or service. The purchase chain includes repeat purchasing, as well as upgrading or buying related products. By thinking through all the related steps, the business can incorporate elements into a product or service at one step of the purchase chain in order to motivate the customer or to drive business in other steps of the chain, thereby delivering enhanced value to customers and increased sales to the company. For example, inserting a coupon on a box of cereal to motivate the customer to purchase that brand of cereal again is an example of changing a product at one stage to motivate or change the customer behavior at another stage. Method 200 is divided into seven stages, each of which contains a number of steps.

### Stage 1: Understanding Onset and Taking Initial Steps

Step 210: Becoming Aware of Hearing Loss as a Natural Condition

In this step, the population at large is educated as to the likelihood of natural hearing loss. As one gets older, hearing gradually diminishes; often imperceptibly. Many people do not know that this is a natural process. In this step, a business might convey this message to the masses via advertisements, posters at general practitioners' offices, and the like.

Step 215. Recognizing Onset of Own Loss

In this step, potential hearing aid users come to understand whether they personally have experienced hearing loss. About 30 million Americans are hearing impaired; while 75 percent of this group acknowledge perceptible loss, only 14 percent are tested. Although each individual is unique, generalizations in hearing loss can be made. Typical signs include (1) shouting when talking to others, (2) needing the TV or radio turned up louder than other people do, (3) often having to ask people to repeat what they say because the individual can't quite hear them, especially in groups or when there is background noise, (4) not being able to hear a noise when not facing the direction it's coming from, (5) seeming to hear better out of one ear than the other, (6) having to strain to hear, (7) hearing a persistent hissing or ringing background noise, and (8) not being able to hear a dripping faucet or the high notes of a violin.

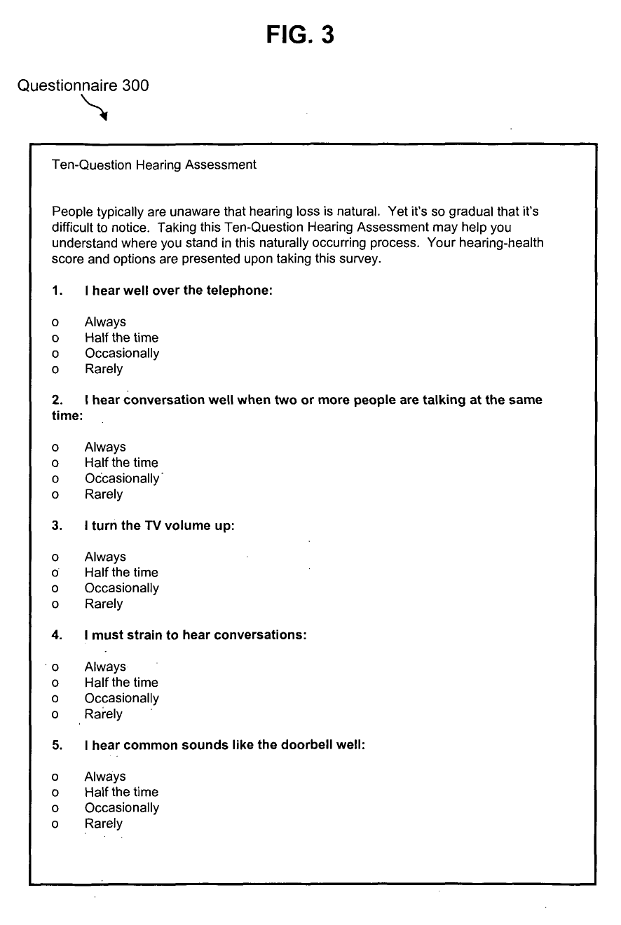

There are many simple ways in which businesses and audiologists can assist potential customers in understanding their individual hearing loss. For example, simple questionnaires can identify hearing loss. FIGS. 3A and 3B illustrate a questionnaire 300 that can be taken by the potential customer. By answering questionnaire 300, the potential customer can further confirm his or her hearing loss, providing a further incentive for the potential customer to take a more in-depth hearing test.

Even though most questionnaires or at-home tests for hearing assessment are private, it would benefit the business to collect the potential customer's name and contact information, so that the individual can be contacted if he or she doesn't visit a hearing health professional in a certain amount of time.

Step 220: Knowing Steps to Treat Loss

In this step, a potential customer must learn the steps to take to treat his or her hearing loss, which may be a separate process from recognizing that the loss exists. In fact, seven years is the average time span from recognizing hearing loss to initiating treatment. For example, a potential customer may decide to not take any further action, to buy a consumer product such as a television or phone amplifier, to take a non-professional test, to talk to a friend, or to take a test administered by a professional audiologist. In any of these cases, the potential customer may make an incorrect choice.

In this step, businesses, audiologists, or hearing aid manufacturers may provide instructions or next steps on questionnaire 300 to direct the potential customer to a Web site, a toll-free telephone number, or a list of local telephone numbers. In almost all cases, the audiologist or hearing aid manufacturer would prefer that the potential customer visit an audiologist for a more professional test. To further prompt the potential customer to conduct a professional test, the name and contact information for preferred audiologists can also be provided. Furthermore, an added incentive, such as “coupon” savings on detailed hearing tests or hearing aid accessories, can also be provided.

### Stage 2: Getting Professional Hearing Test and Assessing Hearing Aid Devices

Step 225: Deciding to Visit Audiologist

In this step; acting on the motivation provided in Stage 1 of method 200, a potential customer decides whether to visit an audiologist to take a hearing test. Currently, only five percent of the hearing-impaired population reaches this step. In case the potential customer decides not to get a professional hearing test, both the processes of education (step 215) and self-assessment (step 220) preferably includes some way to call the potential customer back to see if he or she made the right decision.

Step 230: Diagnosing and Testing

In this step, the customer's name and contact information is captured, starting a more formal process of tracking the individual through the rest of the process. A well-known method of testing hearing loss is used to measure the threshold of the individual's hearing using a calibrated sound-stimulus-producing device and calibrated headphones. The measurement of the threshold of hearing takes place in an isolated sound room, usually a room where there is very little audible noise. The sound-stimulus-producing device and the calibrated headphones used in the testing are known in the art as an audiometer.

If the individual's hearing tests performed using an audiometer show no degradation in hearing, the individual does not proceed to step 235. However, if there is some hearing loss or hearing degradation, the user proceeds to step 235.

Step 235: Deciding to Try and Buy

In this step; the individual has been diagnosed with some hearing loss or degradation and needs to decide if he or she will purchase some type of hearing aid. On average, 80 percent of those tested decide to buy a hearing aid. The audiologist may provide some assistance in making the decision, such as verbally describing the improvement the individual could expect by purchasing a hearing aid or demonstrating a simulated hearing aid test showing what the improvement would be. The object of this step is to provide the customer with the necessary information to make an informed decision. If the individual decides not to buy a hearing aid, the audiologist may suggest follow-up contacts by the audiologists or further visits to monitor the individual over time or even recommend that the individual see another audiologist or seek further information.

### Stage 3: Purchasing Hearing Aid

Step 240: Choosing Product

In this step, the customer chooses which hearing aid to buy. Typically, the audiologist uses the hearing aid test as the basis for the technical decisions as to the hearing aid's capability, but helps the user decide what type of hearing aid is best based upon the lifestyle of the user. For instance, the decision between a behind-the-ear hearing aid and an in-the-ear model is often based upon cosmetic appearance. Beyond this set of choices are issues such as cost of the hearing aid, etc. The audiologist typically suggests manufacturers, price, and quality, and helps the customer decide on the best hearing aid.

Step 245: Being Fitted

In this step, the customer is fitted for the hearing aid, as can be typically done at most audiologists' offices. In current practice, three to five visits are required for required for proper fitting. Depending upon the type of hearing aid purchased, ear measurements and fittings are made. The measurements of the ear, the specifications selected by the individual in terms of hearing aid type, etc., and the hearing test data are sent to the hearing aid manufacturer to custom-make a hearing aid. FIG. 1 of the prior art describes a standard basic hearing aid 100 with DSP 103. The data from the hearing test is used to program DSP 103 as is described with reference to FIG. 1.

### Stage 4: Using Hearing Aid for First Time

Step 250: Waiting for Aid to Arrive

In this step, the customer waits for his or her hearing aid to arrive for the final fitting. In this purchase chain step, the customer is educated on the use of the hearing aid, and may even be educated on the problems associated with initial use of the hearing aid, for example, by reading a pamphlet or book or browsing a Web site.

As he or she is using this waiting time for education, the customer has no way to technically describe to others the extent of his or her hearing loss and how it has impacted his or her communication at home and at work. A new hearing aid initially presents learning challenges that impact the individual's acceptance of the hearing aid, making the individual likely to return it. The valuable time between leaving the audiologist's office after the test and returning for the final hearing aid fitting could be a useful time to educate the customer about his or her individual learning needs. This customer education can be done through low-cost means such as a pre-programmed training CD or via the Internet. Feedback on how the customer responds to the education can be collected and used to fine tune the hearing aid.

Step 255: Using Aid in Audiologist's Office

In this step, the user is fitted with the hearing aid ordered in step 245. As is normally done in the art, the audiologist physically fits the hearing aid and describes its operation: and use to the customer. The audiologist retests the individual with the hearing aid in the individual's ear to explain the performance of the hearing aid. Often, this involves not only sounds at various amplitudes, but also speech intelligibility, shown by reading predefined sentences to the individual. The audiologist may adjust the hearing aid as he or she sees fit. In some hearing aid products, the audiologist may even be able to adjust DSP 103 of FIG. 1 to a point.

A customer may decide not to accept the purchase of the hearing aid because his or her expectations were not met, or for other personal reasons. In this case, the audiologist recommends next steps that can include a free trial, a retest, or a wait-and-see decision, and the individual does not proceed to the next stage of method 200.

### Stage 5: Starting to Use Hearing Aid

Step 260: Using Hearing Aid Alone at Home

In this step, the individual wears the hearing aid at home. There is a significant occurrence of hearing aid returns to the audiologist after individuals have worn their hearing aids for a while. This occurs because the individual determines, within a few weeks of use, that the hearing aid performs strangely. Unlike a prescription for eyeglasses that corrects to near perfect vision, hearing-aids do not restore perfect hearing and may require a significant retraining period. This is particularly true regarding the way the individual interprets speech. Often, as a person loses his or her hearing within a certain frequency range, certain words become troublesome to hear and the individual continually asks a speaker to repeat those words. In essence, the individual is retraining his or her brain to associate the new audio signal with a known concept. Many times, the word is used in a sentence that provides more context for the brain to be retrained. When a new hearing aid is used, the individual now hears a more correct audio signal for those words instead of the incorrect audio signal presented to it by the deficient hearing. However, the brain no longer recognizes the meaning of the more correct audio signal.

In this step, the audiologist may provide at-home training; which could be as simple as instructing the individual to wear the hearing aid for a certain number of hours per day, gradually increasing usage, or as advanced as a more formal training system in which the individual listens to predefined tapes or CDs for training.

Step 265: Keep Hearing Aid?

In this decision step, after having worn the hearing aid for several days, the customer must decide whether to keep the hearing aid. Nearly 20 percent of hearing aids are returned for credit after about 60 days owing to dissatisfaction, often for the same reasons identified in step 260.

In this step, the user may decide to return the hearing aid because the expectations of the user are not met. Since most manufacturers and audiologist provide certain guarantees concerning their product and its use, this return is easily made. If the hearing aid is returned because expectations are not met or for other personal reasons, the audiologist recommends next steps that could include a free trial, a retest, or a wait-and-see decision. Method 200 then ends. If the user decides to keep the hearing aid, method 200 proceeds to step 270.

### Stage 6: Using Hearing Aid Long Term

Step 270: Cleaning and Maintaining

In reaching this step, the user has been trained and the hearing aid has been accepted; however, there are other issues that impact a user's experience with his or her hearing aids, for example, the cleaning and maintenance of the hearing aid. Routine cleaning reduces return rates eight-fold.

In this step, the hearing aid is cleaned and maintained. This could be as simple as wiping the hearing aid each night or cleaning the hearing aid with what a manufacturer-provided cleaning agent. Indeed, there are even self-cleaning hearing aids, see, for example, U.S. Pat. No. 6,349,790, incorporated by reference herein, which describes a thermally-activated cleaning element on the distal end of a hearing aid adjacent to the speaker that retracts when heated by the inner ear to body temperature, then extends when cooled to room temperature. Upon removal of the hearing aid from the ear, the self-cleaning cerumen guard automatically removes any debris that has accumulated in the speaker port

Step 275: Visiting Audiologist for Repair

In this step, the user visits the audiologist for repair of his or her hearing aid. Since the hearing aid is an electronic device, it may need to have its battery replaced, its battery contacts may be eroding, the electronics may be degraded, or the speaker or microphone may be wearing out. The audiologist may suggest, based upon the age of the hearing aid or new unforeseen user requirements, that the user upgrade his or her hearing aid and moves to step 280.

### Stage 7: Deciding to Upgrade

Step 280: Upgrade Hearing Aid?

In this decision step, if the audiologist has recommended that the user upgrade his or her hearing aid, the user decides whether to follow that recommendation. Currently, one hearing aid in five sold is a repeat purchase. If the user decides to upgrade the hearing aid, method 200 returns to step 225. However, if either the user decides not to upgrade or the audiologist has not recommended upgrading, method 200 returns to step 270.

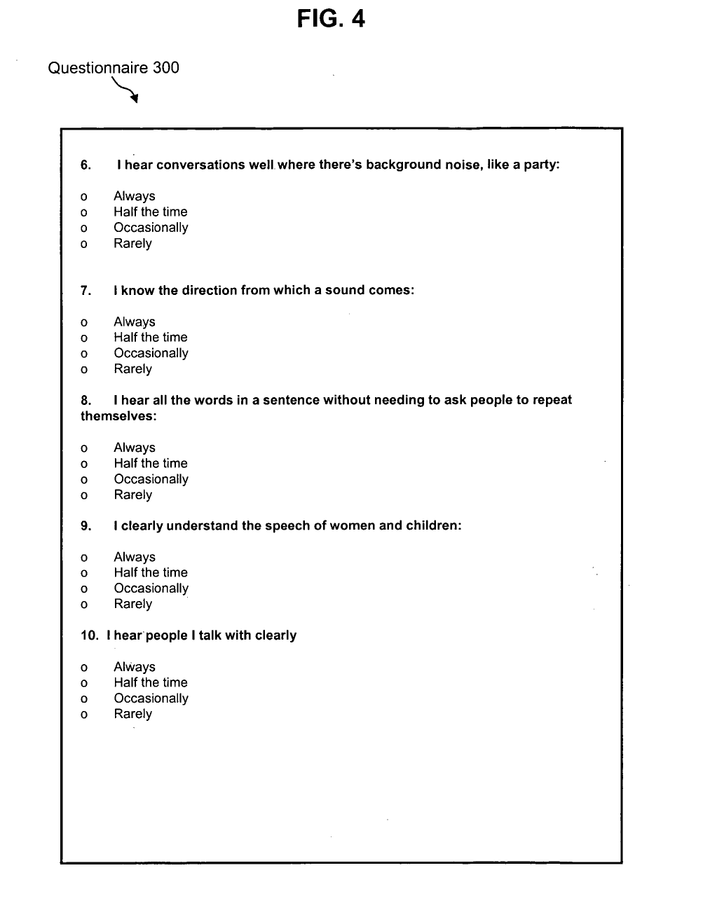

FIG. 4 is a high-level diagram of a system 400, consisting of a user 410; a hearing test unit 415 including a test administration computer 420 with a database 425 and a series of industry standard hearing test programs 446, a pair of headphones 422, a keyboard 423, and a monitor 426; a network connection 430; a device 433; and a central hearing health system 440 including a computer 443, a modem 444, a series of hearing test programs 446 and a user database 445 for storing a set of hearing loss profiles 450. A conventional telephone 421 enables individuals to connect to central hearing health system 440 via modem 444.

User 410 represents an individual upon whom a hearing test is to be administered. Hearing test unit 415 includes test administration computer 420, conventional headphones 422, conventional keyboard 423, and conventional monitor 426, all used for testing. Conventional monitor 426 can graphically display test frequencies and amplitudes for user 410, while user 410 is being tested.

Test administration computer 420 runs current user hearing test programs 446 on central hearing health system 440 and may store the results, of hearing test programs 428 in database 425. Test administration computer 420 is also responsible for communicating with user database 445. User database 445 is a central database repository to store hearing loss profiles 450 associated with user 410 or any other test subject; such profiles can later be reused. User database 445 can store an infinite number of individual hearing loss profiles 450 and these profiles could all be accessible using test administration computer 420 or any other system linked to user database 445.

Network connection 430 is the Internet or other such well-known network, which connects remote computers to host computers.

Device 433 is a consumer electronics product that allows any audio output device such as a home-entertainment speaker system to be driven through it. The amplification of the signals as they are driven from their source to: the speakers, through device 433, is modified by the DSP (not shown) in device 433. These modifications are based upon DSP data from hearing test programs 446 on central hearing health system 440; the DSP data is sent to device 433 via network connection 430 and is stored in device 433. Basically, any information from hearing test programs 446 using hearing loss profiles 450 on central hearing health system 440 is used by device 433 to improve the audio output for the specific user 410.

In operation, user 410 wears headphones 422 and uses keyboard 423 and monitor 426 to take a hearing test using test administration computer 420 and the series of hearing test programs 446 on central hearing health system 440. Hearing loss profiles 450 containing the results of hearing test programs 446 on central hearing health system 440 are stored in user database 445, which can be either within test administration computer 420 or centrally located in database 425.

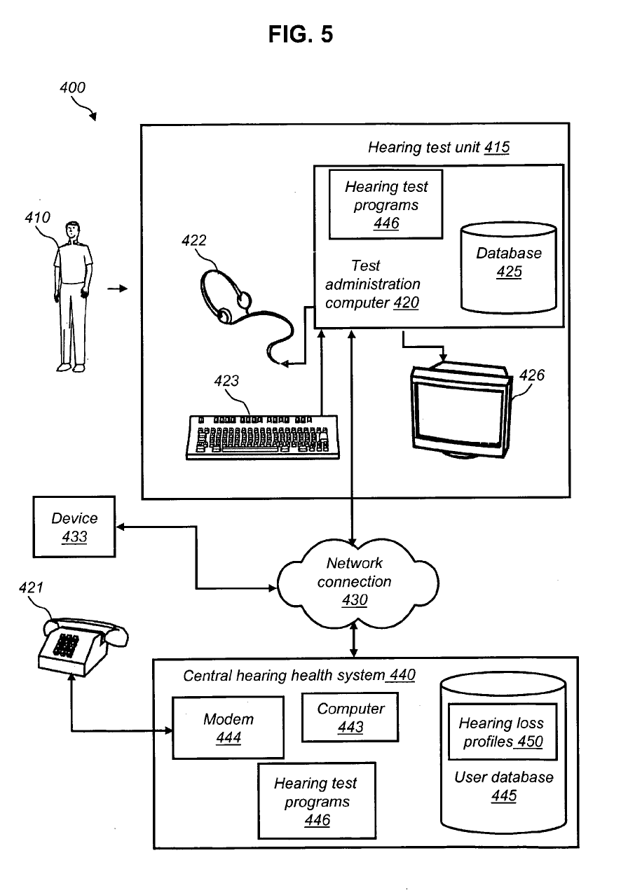

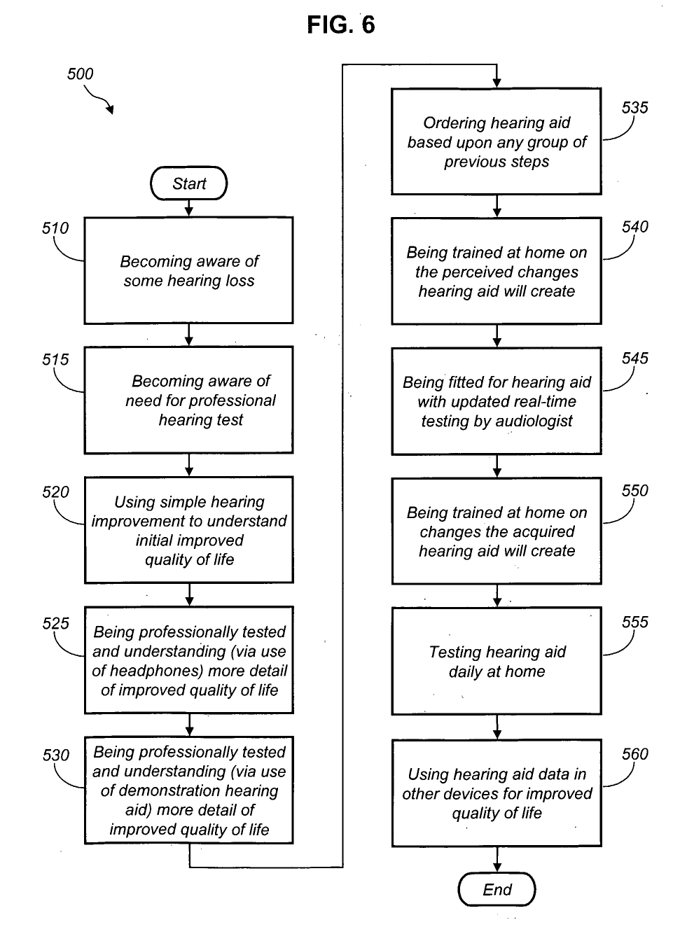

FIG. 5 represents a specific method 500 for implementing the purchase chain of FIG. 2. This specific process operates on system 400. In this embodiment, consumer electronics products are used to create hearing tests and capture data from those hearing tests to motivate the consumer to move through the process.

Step 510: Becoming Aware of Some Hearing Loss

In this step, the population at large is educated as to the likelihood of natural hearing loss. As one gets older, hearing gradually diminishes, often imperceptibly. Many people do not know that this is a natural process. In this step, a business might convey this message to the masses via advertisements, posters at general practitioners' offices, and the like.

In this step, a potential customer receives a hearing testing system stored on a standard low-cost apparatus such as a CD. The individual takes the hearing test by playing the CD and is directed to move through the tracks on the CD based upon his or her responses to questions. The final tracks the potential customer plays determine the unique results of the hearing test. If the potential customer has hearing deficiencies, he or she is directed to gain more information by moving to the next step in method 500. If the hearing test shows that the individual has significant deficiencies or degradation in hearing, he or she is directed to step 520; if not, the individual does not proceed any further.

Step 515: Becoming Aware of Need for Professional Hearing Test

In this step, the potential customer accesses a hearing test stored on central hearing health system 440 of FIG. 4 either through a telephone using a toll-free telephone number, or through an Internet connection to a Web site, both of which are easily mass-marketed. The potential customer can be led to the system by advertisement or by the previous low-cost CD hearing test system. This would allow the mass market of individuals with mild to moderate hearing loss to recognize it at the onset without the need to visit an audiologist.

In this step, the present invention streamlines and connects the low-cost, self-administered hearing test to a professionally administered hearing test by providing results of the hearing test as a code that can be quickly identified by a professional audiologist at the next level of test.

The present invention provides testing of speech intelligibility issues concerning hearing aids, where hearing tests are preferably administered with words based upon the potential customer's responses to the hearing test.

The present invention also provides a way to show the potential customer the impact of having a hearing aid upon his or her quality of life in order to improve the individual's motivation to get a hearing aid, by having the system play corrected words or sounds based upon the hearing loss detected in the hearing test.

The present invention provides step-by-step guidance on the next steps if hearing loss is found. Further, this invention also provides a way to store and organize the individual's test data to create a way to reuse the data.

Step 520: Using Simple Hearing Improvement to Understand Initial Improved Quality of Life

In this step, the present invention provides a low-cost, programmable, time-limited hearing health aid, and a method of programming the hearing health aid with user-specific hearing-loss data for the purpose of emulating the performance of a more permanent, but more costly, hearing aid device. “Time-limited” means that the hearing health aid is designed to be operational for a limited time, and is intended for temporary, evaluative purposes. By providing the individual with a low-cost, but temporary, means to evaluate the benefits of assisted hearing, he or she becomes more comfortable with its use, and therefore is more amenable to the more involved process and greater expense of being fitted for a more permanent hearing health solution.

The method of use for the hearing health aid and the associated programming system provides an individual with hearing loss with an improved way to evaluate the effectiveness of a hearing aid device.

Step 525: Being Professionally Tested and Understanding (Via Use of Headphones) More Detail of Improved Quality of Life

In this step, a well-known method of testing hearing loss in individuals by finding the threshold of the individual's hearing is performed. The hearing threshold is typically measured using a calibrated sound-stimulus-producing device and calibrated headphones, such as found in an audiometer. The measurement of the threshold of hearing takes place in an isolated sound room, usually a room where there is very little audible ambient noise.

In this step, a simulation of a hearing aid environment is created prior to the individual's purchase of a hearing aid. To create the simulated environment, the individual's hearing profile is collected from all prior hearing tests. Previous hearing tests include all aspects of the user's hearing (such as frequency and speech intelligibility).

The audiologist uses the software program of the present invention (hearing test program 446 of FIG. 4), analyzes the individual's hearing profile, and creates a simulation that demonstrates to the individual how he or she would hear with a hearing aid. For example, if the individual has degradation in the high frequency range, i.e., if low pass frequencies are easier to hear, then the simulation creates and plays all the words and sentences that the individual may interpret differently when wearing the hearing aid. Thus, the individual understands through this simulation how these words and sentences will sound with a hearing aid. It is possible at this point to even make further adjustments to the hearing aid DSP data prior to ordering the individual customized hearing aid based upon individual preferences. This helps reduce the rate of return of hearing aids to manufacturers.

Step 530: Being Professionally Tested and Understanding (Via Use of Demonstration Hearing Aid) More Detail of Improved Quality of Life

In this step, the audiologist uses a hearing aid demonstration unit and method of using the hearing aid demonstration unit on an individual with a hearing deficiency prior to the individual's purchase of an actual hearing aid unit. The individual is tested to determine his or her hearing loss profile, and then retakes the test with a programmed hearing aid prior to his or her purchase of the customized unit. When the individual receives the actual customized unit, he or she is better aware of what to expect from his or her purchased unit and therefore will be more satisfied with the unit, thereby reducing the rate of return on hearing aid units to manufacturers.

Step 535: Ordering Hearing Aid Based Upon any Group of Previous Steps

In this step, the individual has been diagnosed with some hearing loss or degradation and needs to decide whether he or she will purchase some type of hearing aid. The audiologist may provide some assistance in making the decision, such as verbally describing the improvement the individual could expect by purchasing a hearing aid and demonstrating a simulated hearing aid test showing what the improvement would be. The object of this step is to provide the individual with the necessary information to make an informed decision.

In this step, an individual chooses which hearing aid to buy. Typically, the audiologist uses the hearing aid test as the basis for the technical decisions as to the hearing aid's capability, but helps the user decide what type of hearing aid is best based upon lifestyle of the user. For instance, the decision between a behind-the-ear hearing aid and an in-the-ear model is often based upon appearance. Beyond this set of choices are issues such as cost. The audiologist typically suggests manufacturers, price, and quality, and helps the customer decide among behind-the-ear, in-the-ear, and completely-in-the-canal models of hearing aids.

Step 540: Being Trained at Home with Perceived Changes the Hearing Aid Will Create

In this step, the individual uses a training product that has been customized based on his or her hearing profile. This step also provides a method of collecting user information by conducting a hearing test and storing it in a database. This invention also provides a method of determining specific troublesome content, i.e., words that are likely to be difficult for the individual to understand, based on his or her hearing profile. This content can be changed to any frequency and amplitude by using a DSP. This hearing test data plus DSP modifications allows the creation of a customized CD training system, with which the user can train his or her brain before he or she has received the hearing aid, thus reducing the number of returns of hearing aids. Furthermore, the content can be output to a CD using a low-cost system with minimal waiting by the consumer. Finally, this invention provides a method of easily interacting with the training CD.

Step 545: Being Fitted for Hearing Aid with Updated Real-Time Testing by Audiologist

In this step, the audiologist uses a simultaneous hearing test and hearing aid tuning and programming system and method that use the individual's actual hearing aid in the individual's ear. Audiologists and individuals interact in real time as the audiologist sends a test tone or other sound, such as a given volume in a single frequency range, then asks the individual as to the test tone's suitability (such as loudness). The hearing aid is further tuned and reprogrammed accordingly as the sound is replayed and the individual gives additional feedback. These steps continue until the individual considers the hearing aid optimized to his or her satisfaction and preferences. The optimal loudness for the frequency is programmed on the spot into the hearing aid via a series of modulated high frequency sound waves, e.g., waves above 20 kHz, or via other wired or wireless device emanating from the audiologist's tone generator, and is then received and decoded by the hearing aid's DSP. The process is repeated for each of a set number (typically twelve) of frequency ranges. Further testing and programming similarly administered addresses users' rehabilitation needs, such as compensating for ambient noises in day-to-day settings that interfere with hearing conversations.

Step 550: Being Trained at Home on Changes the Acquired Hearing Aid Will Create

In this step, the individual uses a customized training product based on his or her hearing profile, assuming the individual is already wearing a programmed hearing aid. Based on the individual's hearing profile and the response the hearing aid provides; this invention also provides a method of determining specific, troublesome content, i.e., words the user may find difficult to understand. Such a word as “elephant” is changed in frequency and amplitude using the DSP in the hearing aid. This hearing test data, in addition to known DSP changes, allows the creation of a customized CD training system of words and words in sentences that can be used to train a user with a hearing aid, thus minimizing the returns of hearing aids. Furthermore, the content can be output to a CD-using a low-cost system with minimal waiting by the consumer. Finally, this step of the invention provides a way to easily interact with the training CD.

Step 555: Testing Hearing Aid Daily at Home

In this step, the individual uses a means for automatic, routine diagnostic testing of hearing aid function, in the individual's home, as frequently as daily. The hearing aid is placed in a small countertop device at regular intervals, such as at the end of each day, the device can test the audio frequency range for which the hearing aid is designed and for which the device is soundproof. The device tests the hearing aid for proper function by pinging it with a series of audio waves, after which the device signals the individual as appropriate of such status as proper function, service required, etc. Additionally, the apparatus may be connected via Internet or other network to a central computer that remotely further diagnoses the hearing aid, such as by issuing a series of corrective tones, to provide some degree of servicing if the hearing aid is programmable, for instance, adding amplification in response to the hearing aid's normal degradation over time. This networking capability also enables continuous updating of an individual's file on the central computer, for reference and analysis by audiologists and other stakeholders for ways to continually improve individuals' hearing.

Step 560: Using Hearing Aid Data in Other Devices for Improved Quality of Life

In this step, the individual wearing the programmable hearing aid can take advantage of its programmability (either wired or wirelessly), such as when the hearing aid is programmed to be optimized for a particular scenario. For instance, the individual could attend an opera and the opera house, having been alerted of the individual's attendance by a previous business arrangement, would have predefined its acoustics and would know the best seating for the individual based upon access to his or her hearing test results on central hearing health system 440 of FIG. 4. The opera house could also use the hearing test result information to broadcast codes to program the hearing aid for best results.

Thus, the inventive system and method increases convenience to users to drive the hearing-health purchase process which can result in purchase of a hearing aid. The system includes a central hearing health database containing customer information gathered over the purchase chain, and makes the information accessible to any of the stages of the purchase chain, resulting in more customer convenience, in turn, increasing sales. The purchase chain is a representation of the interaction between the customer and a business entity. Businesses think through everything from educating the customer on their product or service to how to motivate the customer to try and buy the product or service. The purchase chain also includes repeat purchasing, as well as upgrading or buying related products. By thinking through all the related steps, the business can incorporate elements into a product or service at one step of the purchase chain in order to motivate the customer and to drive business in other steps of the chain, thereby delivering enhanced value to customers and increased sales to the company.

Although preferred embodiments of the present invention have been described and illustrated, it will be apparent to those skilled in the art that various modifications may be made without departing from the principles of the invention.

What is claimed is:

1. A hearing loss testing and training data storage media comprising:
at least one of (i) an executable hearing aid testing program including a plurality of testing units, (ii) an executable hearing aid training program including a plurality of training units, and (iii) hearing aid testing data;
at least one of a plurality of hearing aid diagnosis units corresponding to a hearing loss profile obtainable based on performance of the hearing aid testing program;
at least one hearing aid product unit representative of a hearing aid product programmable to operate based on at least one of the hearing aid diagnosis units;
wherein at least one of the training units is linked to at least one of the hearing aid testing data and the at least one diagnosis units; and
wherein the training program, based on user input data, accesses at least one of the training units.

2. The media of claim 1 further comprising:
incentive data linked to at least one of the testing units.

3. The media of claim 2, wherein the incentive data includes electronic coupons.

4. The media of claim 1, wherein the diagnosis units include digital signal processor correction factors data.

5. The media of claim 1, wherein the user input data is provided over a communications network interface or at a local computer interface.

6. The media of claim 1 further comprising:
at least one hearing aid maintenance program and wherein at least one of the diagnosis units is indexed with user identification data.

7. The media of claim 1 further comprising:
hearing aid environment data including at least one sound code for programming a programmable hearing aid to operate using a modified version of at least one of the diagnosis units, wherein the modified diagnosis unit includes digital signal processor correction factors modified based on acoustic environment data for an identified location.

8. The media of claim 7, wherein the programming is performed wirelessly or through wired means.

9. The media of claim 1 further comprising:
multimedia hearing aid data, wherein the multimedia data includes audio input modification data representative of digital signal processor correction factors included in at least one of the diagnosis units.

10. The media of claim 9, wherein the multimedia data includes data for modifying text captioning or audio signals.

11. An electronic audio signal modification device for coupling to at least one electronic audio device including an audio signal output, the modification device comprising:
a digital signal processor (“DSP”) for modifying input audio signals received from the electronic audio device using DSP correction factors received at a network communications interface and stored at a hearing loss profile data storage media, and
wherein the modified audio signals are for driving an analog audio output device coupled to the electronic audio device.

12. A method for providing hearing loss information to an individual comprising:
providing a hearing loss testing and training data storage media for use in collecting hearing loss profile information from an individual;
providing hearing aid selection information to the individual based on diagnostic information obtained using the hearing loss profile information; and
training the individual concerning use of a selected hearing aid.

13. The method of claim 12, wherein the training is performed at least one of preceding and following the individual's receipt of the selected hearing aid.

14. The method of claim 12 further comprising:
generating hearing aid programming information during performance of an automated maintenance routine on the hearing aid.

15. A system for providing hearing loss information to an individual comprising:
a hearing loss testing and training data storage media for use in collecting hearing loss profile information from an individual;
a hearing loss diagnostic apparatus for generating diagnostic information for an individual based on the hearing loss profile information, wherein the diagnostic information is useful for hearing aid selection; and
a training device for training the individual concerning use of a selected hearing aid preceding and following the individual's receipt of the selected hearing aid.

16. The system of claim 15 further comprising:
an automated hearing aid maintenance device for cleaning and testing the hearing aid and generating hearing aid programming information based on the testing.
